(19) United States
(12) Patent Application Publication
(10) Pub. No.: US 2024/0332735 A1
(43) Pub. Date: Oct. 3, 2024

(54) NONAQUEOUS ELECTROLYTE SECONDARY BATTERY SEPARATOR, NONAQUEOUS ELECTROLYTE SECONDARY BATTERY MEMBER, AND NONAQUEOUS ELECTROLYTE SECONDARY BATTER

(71) Applicant: Sumitomo Chemical Company, Limited, Tokyo (JP)

(72) Inventors: Akihiko SHIN, Niihama-shi (JP); Yuki YONEGUCHI, Niihama-shi (JP)

(21) Appl. No.: 18/622,850

(22) Filed: Mar. 29, 2024

(30) Foreign Application Priority Data
Mar. 31, 2023 (JP) 2023-059118

(51) Int. Cl. H01M 50/449; H01M 50/417; H01M 50/423

(52) U.S. Cl. CPC H01M 50/449; H01M 50/417; H01M 50/423

(57) ABSTRACT

Provided is a nonaqueous electrolyte secondary battery separator capable of satisfactorily maintaining ion permeability even after being compressed. The nonaqueous electrolyte secondary battery separator includes a polyolefin porous film for which, when a two-dimensional image obtained from a cross section using SEM under a condition that one pixel is 19.8 μm×19.8 μm is repeatedly subjected to a process in which each of target pixels constituting a void part region is expanded by 1 pixel per stage toward each of four pixels which are adjacent to respective four sides of that target pixel, the number of necessary stages until a resin part region other than the void part is filled with the void part region is not more than 20 stages.

This Nonprovisional application claims priority under 35 U.S.C. § 119 on Patent Application No. 2023-059118 filed in Japan on Mar. 31, 2023, the entire contents of which are hereby incorporated by reference.

### TECHNICAL FIELD

The present invention relates to a separator for a nonaqueous electrolyte secondary battery (hereinafter referred to as a “nonaqueous electrolyte secondary battery separator”), a member for a nonaqueous electrolyte secondary battery (hereinafter referred to as a “nonaqueous electrolyte secondary battery member”), and a nonaqueous electrolyte secondary battery.

### BACKGROUND ART

Nonaqueous electrolyte secondary batteries such as a lithium secondary battery are currently in wide use as (i) batteries for devices such as a personal computer, a mobile telephone, and a portable information terminal or (ii) on-vehicle batteries.

As a separator for use in such a nonaqueous electrolyte secondary battery, a porous film containing polyolefin as a main component is mainly used. Examples of the porous film containing polyolefin as a main component encompass a porous film produced by the method disclosed in Patent Literature 1, which includes a step of stretching a resin composition containing a polyolefin-based resin.

### CITATION LIST

### Patent Literature

[Patent Literature 1]
Japanese Patent Application Publication Tokukaihei No. 11-130900

### SUMMARY OF INVENTION

### Technical Problem

In recent years, development of high-capacity batteries has been ongoing for use in applications such as an electric vehicle (EV) with a greater cruising range. As an example of the high-capacity battery, a nonaqueous electrolyte secondary battery including a silicon electrode as a negative electrode has been developed. However, it is known that, as compared with a conventional negative electrode, a negative electrode (such as a silicon electrode) in a high-capacity battery expands in charging and discharging, so that a volume of the negative electrode changes by, for example, approximately 4 times. As a result, in the high-capacity battery, an internal pressure inside the battery (cell) is further increased. Due to the increase in internal pressure, the high-capacity battery has the following problem that the separator is compressed in charging and discharging, and this leads to blocking of a void (hole) inside the separator, and this results in a decrease in permeability of ions that are charge carriers.

In order to solve the problem, an object of an aspect of the present invention is to provide a nonaqueous electrolyte secondary battery separator that is capable of satisfactorily maintaining ion permeability even after being compressed.

### Solution to Problem

As a result of diligent studies, the inventors of the present invention have found that a nonaqueous electrolyte secondary battery separator including a polyolefin porous film in which a distance between voids is small can satisfactorily maintain ion permeability even after being compressed. The inventors of the present invention have also found that the distance between voids can be evaluated using the number of repetitions until a part other than the voids cannot be observed in a cross section of the polyolefin porous film when repeating a process of enlarging a size of a void part under predetermined conditions with respect to the cross section of the polyolefin porous film. Based on the above matters, the inventors of the present invention have conceived of the present invention.

An aspect of the present invention is a nonaqueous electrolyte secondary battery separator including a polyolefin porous film, in which: when a binarized image is obtained by subjecting a two-dimensional image, which has a size of 960 pixels (thickness direction)×1280 pixels (MD) and which has been obtained from a cross section of the polyolefin porous film using a scanning electron microscope under conditions that a magnification is 5,000 times and one pixel is 19.8 μm×19.8 μm, to binarization into a void part region and a resin part region, and then the binarized image is subjected to an expansion process of expanding the void part region in stages, the number of necessary stages until the resin part region is filled with the void part region which has been expanded is not more than 20 stages; the expansion process is a process of repeating an operation of expanding each of target pixels constituting the void part region by 1 pixel per stage toward each of four pixels which are adjacent to respective four sides of that target pixel; and the expansion process and calculation of the number of necessary stages are carried out with the steps of
(1) extracting, from the two-dimensional image, an analysis region having a size of 100 pixels (thickness direction)×1280 pixels (MD),
(2) carrying out, with respect to the analysis region extracted in the step (1), a process of adaptive histogram equalization of a luminance value,
(3) carrying out a luminance inversion process with respect to the analysis region which has been subjected to the process of adaptive histogram equalization of a luminance value in the step (2),
(4) carrying out binarization by dividing all pixels constituting the analysis region which has been subjected to the luminance inversion process in the step (3) into pixels in which a luminance value is not more than a threshold of 180 and pixels in which a luminance value is more than the threshold of 180 within a luminance value range between 0 and 255, (5) identifying, in the analysis region binarized in the step (4), a region constituted by the pixels in which the luminance value is more than the threshold of 180 as a void part region,
(6) carrying out, for each of void regions identified in the step (5) in the analysis region, an expansion operation in which each of pixels constituting a contour of that void part region is expanded by 1 pixel outwardly toward each of four adjacent pixels,
(7) carrying out a blob process with respect to a resin part region, which is a region other than the void part region subjected to the expansion operation in the step (6), counting the number of pixels constituting the resin part region, where the number of pixels thus counted is defined as the number of resin part regions, and then checking whether the number of resin part regions counted is 0 or not,
(8) ending the calculation of the number of necessary stages if the number of resin part regions counted in the step (7) is 0, repeating the processes described in the steps (6) and (7) until the number of resin part regions becomes 0 if the number of resin part regions is not 0, and ending the calculation of the number of necessary stages when the number of resin part regions has become 0, and
(9) calculating the number of times in which the processes described in the steps (6) and (7) have been repeated until the calculation of the number of necessary stages is ended in the step (8), and regarding the number of times thus calculated as the number of necessary stages.

### Advantageous Effects of Invention

The nonaqueous electrolyte secondary battery separator in accordance with an aspect of the present invention brings about an effect of being capable of satisfactorily maintaining ion permeability even after being compressed.

### BRIEF DESCRIPTION OF DRAWINGS

FIG. 1 is a schematic view illustrating a process of expanding a void part region in stages in the present invention.

### DESCRIPTION OF EMBODIMENTS

The following description will discuss embodiments of the present invention. Note, however, that the present invention is not limited to these embodiments. The present invention is not limited to arrangements described below, but may be altered in various ways by a skilled person within the scope of the claims. The present invention also encompasses, in its technical scope, any embodiment derived by combining technical means disclosed in differing embodiments. Any numerical range expressed as “A to B” herein means “not less than A and not more than B” unless otherwise stated.

Herein, the term “machine direction” (MD) refers to a direction in which a polyolefin resin composition in sheet form and a porous film are transferred in a method of producing a porous film (described later). The term “transverse direction” (TD) refers to a direction which is (i) perpendicular to the MD and (ii) parallel to a surface of the polyolefin resin composition in sheet form and a surface of the porous film.

If a production method is unknown, that is, a direction in which the polyolefin resin composition in sheet form and the porous film which are raw materials are transferred is unknown, the MD of the nonaqueous electrolyte secondary battery separator and the porous film that constitutes the nonaqueous electrolyte secondary battery separator refers to a longitudinal direction (cylindrical type: a winding direction, continuous fanfold type: a folding-back direction) of the film. The TD in the nonaqueous electrolyte secondary battery separator and the porous film refers to a direction which is (i) parallel to a surface of the nonaqueous electrolyte secondary battery separator and a surface of the porous film and (ii) perpendicular to the MD.

### Embodiment 1: Nonaqueous Electrolyte Secondary Battery Separator

A nonaqueous electrolyte secondary battery separator in accordance with Embodiment 1 of the present invention is a nonaqueous electrolyte secondary battery separator including a polyolefin porous film, in which: when a binarized image is obtained by subjecting a two-dimensional image, which has a size of 960 pixels (thickness direction)×1280 pixels (MD) and which has been obtained from a cross section of the polyolefin porous film using a scanning electron microscope under conditions that a magnification is 5,000 times and one pixel is 19.8 μm×19.8 μm, to binarization into a void part region and a resin part region, and then the binarized image is subjected to an expansion process of expanding the void part region in stages, the number of necessary stages until the resin part region is filled with the void part region which has been expanded is not more than 20 stages; the expansion process is a process of repeating an operation of expanding each of target pixels constituting the void part region by 1 pixel per stage toward each of four pixels which are adjacent to respective four sides of that target pixel; and the expansion process and calculation of the number of necessary stages are carried out with the steps of
(1) extracting, from the two-dimensional image, an analysis region having a size of 100 pixels (thickness direction)×1280 pixels (MD),
(2) carrying out, with respect to the analysis region extracted in the step (1), a process of adaptive histogram equalization of a luminance value,
(3) carrying out a luminance inversion process with respect to the analysis region which has been subjected to the process of adaptive histogram equalization of a luminance value in the step (2),
(4) carrying out binarization by dividing all pixels constituting the analysis region which has been subjected to the luminance inversion process in the step (3) into pixels in which a luminance value is not more than a threshold of 180 and pixels in which a luminance value is more than the threshold of 180 within a luminance value range between 0 and 255,
(5) identifying, in the analysis region binarized in the step (4), a region constituted by the pixels in which the luminance value is more than the threshold of 180 as a void part region,
(6) carrying out, for each of void regions identified in the step (5) in the analysis region, an expansion operation in which each of pixels constituting a contour of that void part region is expanded by 1 pixel outwardly toward each of four adjacent pixels,
(7) carrying out a blob process with respect to a resin part region, which is a region other than the void part region subjected to the expansion operation in the step (6), counting the number of pixels constituting the resin part region, where the number of pixels thus counted is defined as the number of resin part regions, and then checking whether the number of resin part regions counted is 0 or not,
(8) ending the calculation of the number of necessary stages if the number of resin part regions counted in the step (7) is 0, repeating the processes described in the steps (6) and (7) until the number of resin part regions becomes 0 if the number of resin part regions is not 0, and ending the calculation of the number of necessary stages when the number of resin part regions has become 0, and
(9) calculating the number of times in which the processes described in the steps (6) and (7) have been repeated until the calculation of the number of necessary stages is ended in the step (8), and regarding the number of times thus calculated as the number of necessary stages.

The nonaqueous electrolyte secondary battery separator in accordance with an embodiment of the present invention includes a polyolefin porous film. Hereinafter, the polyolefin porous film may be referred to simply as a “porous film”. Hereinafter, the nonaqueous electrolyte secondary battery separator may be referred to simply as “separator”.

The separator in accordance with an embodiment of the present invention can be a separator that is constituted by the porous film. The separator in accordance with an embodiment of the present invention can be a separator that is a laminate including the porous film and an insulating porous layer (described later). Hereinafter, a separator that is a laminate including the porous film and the insulating porous layer (described later) may also be referred to as a “laminated separator”. The separator in accordance with an embodiment of the present invention can, as necessary, include a publicly known porous layer other than the insulating porous layer, such as a heat-resistant layer, an adhesive layer, and/or a protective layer as described later.

In an embodiment of the present invention, the number of necessary stages is the number of stages until a resin part region is filled with a void part region which has been expanded in stages in a binarized image by repeating an operation in which each of target pixels constituting the void part region is expanded by 1 pixel per stage toward each of four pixels which are adjacent to respective four sides of that target pixel. The binarized image is obtained as follows: a two-dimensional image having a size of 960 pixels (thickness direction)×1280 pixels (MD) is obtained from a cross section of the porous film using a scanning electron microscope (SEM) under conditions that a magnification is 5,000 times and one pixel is 19.8 μm×19.8 μm; and the two-dimensional image is subjected to binarization into the void part region and the resin part region to obtain the binarized image. Here, when each of target pixels constituting the void part region is expanded by 1 pixel toward each of four pixels which are adjacent to respective four sides of that target pixel, each of pixels constituting the contour of the void part region is expanded by 1 pixel outwardly toward each of four adjacent pixels, as the entire void part region. The cross section is a cross section formed by cutting the porous film in an arbitrary direction.

The expansion process and calculation of the number of necessary stages are carried out with the steps of
(1) extracting, from the two-dimensional image, an analysis region having a size of 100 pixels (thickness direction)×1280 pixels (MD),
(2) carrying out, with respect to the analysis region extracted in the step (1), a process of adaptive histogram equalization of a luminance value,
(3) carrying out a luminance inversion process with respect to the analysis region which has been subjected to the process of adaptive histogram equalization of a luminance value in the step (2),
(4) carrying out binarization by dividing all pixels constituting the analysis region which has been subjected to the luminance inversion process in the step (3) into pixels in which a luminance value is not more than a threshold of 180 and pixels in which a luminance value is more than the threshold of 180 within a luminance value range between 0 and 255, (5) identifying, in the analysis region binarized in the step (4), a region constituted by the pixels in which the luminance value is more than the threshold of 180 as a void part region, (6) carrying out, for each of void regions identified in the step (5) in the analysis region, an expansion operation in which each of pixels constituting a contour of that void part region is expanded by 1 pixel outwardly toward each of four adjacent pixels,
(7) carrying out a blob process with respect to a resin part region, which is a region other than the void part region subjected to the expansion operation in the step (6), counting the number of pixels constituting the resin part region, where the number of pixels thus counted is defined as the number of resin part regions, and then checking whether the number of resin part regions counted is 0 or not,
(8) ending the calculation of the number of necessary stages if the number of resin part regions counted in the step (7) is 0, repeating the processes described in the steps (6) and (7) until the number of resin part regions becomes 0 if the number of resin part regions is not 0, and ending the calculation of the number of necessary stages when the number of resin part regions has become 0, and
(9) calculating the number of times in which the processes described in the steps (6) and (7) have been repeated until the calculation of the number of necessary stages is ended in the step (8), and regarding the number of times thus calculated as the number of necessary stages.

As the measurement of a luminance value, a luminance value of each pixel was measured at 256 stages from 0 to 255, where a luminance value of a darkest pixel in the analysis region was defined as 0 and a luminance value of a brightest pixel in the analysis region was defined as 255. Therefore, a luminance value of each of the pixels in the analysis region is defined by any numerical value between 0 and 255.

In general, it is difficult to obtain a uniform illumination state in a whole area of a two-dimensional image when obtaining the two-dimensional image using SEM. Therefore, in the two-dimensional image and an analysis region extracted from the two-dimensional image, the light and darkness can slightly vary from area to area. Therefore, the two-dimensional image can be, for example, an “image in which a central part thereof is relatively bright and which is gradually darkened toward a periphery thereof”. When an analysis region extracted from such a two-dimensional image is directly binarized by a uniform threshold, a void part may be extracted by one size smaller or larger than an actual size depending on the area. Therefore, the analysis region cannot be correctly divided into the void part region and the resin part region, i.e., cannot be accurately binarized. As such, with the above method of measuring the number of necessary stages that utilizes binarization with a fixed threshold, it is impossible to accurately measure the number of necessary stages.

In contrast, the adaptive histogram equalization process is a process of equalizing a histogram in an adaptive manner. Specifically, as described in Examples, the analysis region is divided into a plurality of regions each having a size of, for example, 8 pixels (longitudinal)×8 pixels (transverse), and the histogram is equalized in each of the plurality of regions. The process of equalizing a histogram is a process of expanding a histogram of an image to an entire region (0 to 255 because 1 pixel is 8 bits). The adaptive histogram equalization process allows the entire analysis region to be uniform in brightness and makes it possible to binarize the analysis region with a uniform threshold. Therefore, even if there is nonuniformity in light and darkness according to area in the analysis region, the nonuniformity is resolved in an analysis region which has been subjected to the adaptive histogram equalization process (hereinafter, also referred to as an “analysis region after adaptive histogram equalization process”). As a result, in the entire analysis region after adaptive histogram equalization process, the plurality of void part regions are represented by the same luminance value, and the plurality of resin part regions having the same structure are represented by the same luminance value. Therefore, the analysis region after adaptive histogram equalization process can be correctly divided into the void part region and the resin part region based on the luminance value, i.e., can be accurately binarized. This makes it possible to accurately measure the number of necessary stages with the method of measuring the number of necessary stages that utilizes binarization with a fixed threshold.

The adaptive histogram equalization process is a process generally carried out in binarizing an analysis region constituted by a predetermined number of pixels based on a luminance value. This process can be carried out by a person skilled in the art with an open source program. Examples of such an open source program include “OpenCV: cv::CLAHE Class Reference” that was used in Examples. When the adaptive histogram equalization process is carried out using the open source program, the adaptive histogram equalization process is typically carried out automatically, and it is not necessary to input parameters and the like.

Specifically, for example, the process including the above described steps (1) through (9) are carried out by a method including the following steps (1a) through (8a):
(1a) The porous film is cut in an arbitrary direction to form a cross section.
(2a) A deposited film for SEM observation is formed on the cross section formed in the step (1a).
(3a) For the cross section on which the deposited film has been formed in the step (2a), a reflection electron image is observed under conditions in which an acceleration voltage is 0.8 kV, an operating distance is 3.0 mm, one pixel is 19.8 μm×19.8 μm, and a magnification is 5,000 times, using SEM. Thus, an SEM image (two-dimensional image) of the cross section is obtained.
(4a) From the cross-sectional SEM image obtained in the step (3a), an analysis region having a predetermined size (100 pixels (thickness direction)×1280 pixels (MD)) is extracted.
(5a) With respect to the analysis region extracted in the step (4a), a process of adaptive histogram equalization of a luminance value is carried out.
(6a) With respect to the analysis region which has been subjected to the process of adaptive histogram equalization of a luminance value in the step (5a), a luminance inversion process is carried out in order to accurately identify a void part when carrying out binarization described below.
(7a) The analysis region, which has been subjected to the luminance inversion process in the step (6a), is binarized with a threshold value of 180 within a luminance value range between 0 and 255, and the analysis region is divided into a void part region constituted by pixels in which a luminance value is more than the threshold of 180 and a resin part region constituted by pixels in which a luminance value is not more than the threshold of 180. Note that the resin part region refers to a region other than the void part region. For example, if the porous film contains another component other than a resin such as a filler, a region constituted by the another components is also dealt with as the resin part region.
(8a) With respect to the analysis region which has been binarized in the step (7a), an operation, in which each of target pixels constituting the void part region is expanded by 1 pixel per stage toward each of four pixels which are adjacent to respective four sides of that target pixel, is repeated until the resin part region is filled with the void part region which has been expanded. The number of times the above operation has been repeated is calculated as the number of necessary stages. Note that a state in which the resin part region is filled with the void part region which has been expanded refers to a state in which the entire analysis region is occupied only by the void part region which has been expanded, and the number of pixels constituting the resin part region is 0.

In the step (1a), the cross section is not limited to a particular one. Examples of the cross section include a cross section formed by cutting the porous film in a direction perpendicular to a surface of the porous film along a straight line that passes a center of the surface of the porous film and is parallel to the MD or the TD.

In the step (1a), the porous film may be replaced with a laminated separator that includes, in addition to the porous film, another layer such as an insulating porous layer.

In the step (1a), a method of cutting the porous film is not limited to a particular one, and a publicly known method can be employed. The cutting method can be, for example, an ion milling method. If the laminated separator is cut in the step (1a), a cutting method identical with that in the case of cutting the porous film can be employed.

In the step (2a), the deposited film may be a typical deposited film that can be used in observation of a reflection electron image using SEM. The deposited film may be, for example, a deposited film constituted by osmium. The deposited film can be formed by a publicly known method.

In the step (4a), as the analysis region, an analysis region including the entire cross section of the porous film may be extracted. Alternatively, a plurality of analysis regions each having a predetermined size may be extracted from arbitrary locations in the cross section of the porous film. When a plurality of analysis regions are extracted, the number of necessary stages is calculated by the method described in the steps (5a) through (8a) from each of the plurality of analysis regions. Then, an average of a plurality of numbers of necessary stages calculated from the respective plurality of analysis regions is regarded as the number of necessary stages in an embodiment of the present invention. If a laminated separator including the another layer is cut, the analysis region only needs to include a whole or part of a cross section of the porous film. In other words, a cross-sectional region of the another layer does not need to be included in the analysis region.

As an extraction condition for extracting the plurality of analysis regions, it is preferable to extract three or more analysis regions, and more preferably five or more analysis regions. An area of each of the plurality of extracted analysis regions is preferably not less than 20% and more preferably not less than 40% with respect to the entire cross-sectional area of the porous film. It is preferable that the plurality of analysis regions are extracted from respective regions which do not overlap each other in the cross section of the porous film. If the above-described preferable extraction conditions for extracting a plurality of analysis regions are satisfied, an aspect of the entire porous film can be suitably evaluated.

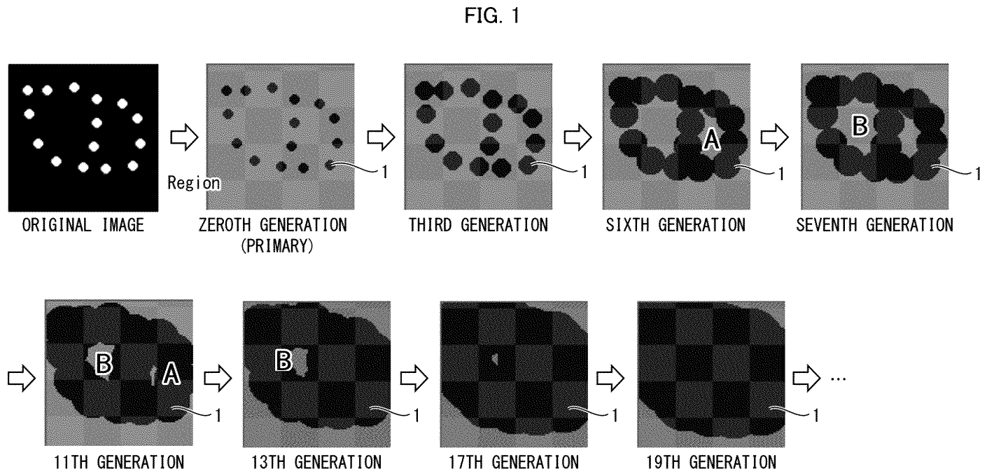

With reference to FIG. 1, the following description will schematically discuss a process of repeating the operation of expanding the void part region in the step (8a), that is, a process of expanding the void part region in stages. FIG. 1 is a schematic view illustrating a process of expanding a void part region in stages. The analysis region which has been binarized in the step (7a) corresponds to an image represented by the zeroth generation in FIG. 1. The analysis region after n times of repetition of the operation of expanding the void part region corresponds to an image represented by the n-th generation in FIG. 1. Regions (such as a region A and a region B) other than the void part region 1 in FIG. 1 are the resin part region. As illustrated in FIG. 1, as n in the n-th generation increases, for example, the resin part region such as the region A and the region B is reduced in size. Therefore, it can be seen that as n increases, the resin part region eventually disappears. The n at which the resin part region eventually disappears is defined as the number of necessary stages herein. Note that, in FIG. 1, the image represented by the 19th generation includes the resin part region remaining at the outside. When the resin part region eventually disappears, the entire analysis region is occupied by the void part region 1. That is, the image in FIG. 1 is occupied by a black color that represents the void part region 1. The number of stages necessary for the entire analysis region to be occupied by the void part region is defined as the number of necessary stages.

For the separator in accordance with an embodiment of the present invention, the number of necessary stages is small, i.e., not more than 20 stages. The number of necessary stages is a parameter that represents a distance between adjacent voids in the entire porous film. If the number of necessary stages is small, the distance between adjacent voids is small. Therefore, the small number of necessary stages means that voids are uniformly and densely distributed throughout the porous film.

In a nonaqueous electrolyte secondary battery, pressure is applied in a direction perpendicular to a surface of a separator and a porous film that constitutes the separator, due to expansion of an electrode (e.g., a negative electrode). In the porous film having voids which are uniformly and densely distributed, the voids themselves have high strength, and the pressure is not concentrated on one point. Therefore, the voids are difficult to deform and are difficult to block with respect to the pressure. Therefore, the separator in accordance with an embodiment of the present invention for which the number of necessary stages is not more than 20 stages brings about effects that the separator includes a porous film in which voids are uniformly and densely distributed, and the voids are not easily blocked even after being compressed, and this makes it possible to satisfactorily maintain ion permeability.

In view of satisfactorily maintaining ion permeability even after being compressed, it is preferable that the number of necessary stages is small. Specifically, an upper limit of the number of necessary stages is preferably not more than 19, and more preferably not more than 18. A lower limit of the number of necessary stages is typically not less than 10, and preferably not less than 12.

The porous film contains a polyolefin-based resin. Typically, the porous film contains the polyolefin-based resin as a main component. Note that the phrase “contains a polyolefin-based resin as a main component” means that a porous film contains a polyolefin-based resin at a proportion of not less than 50% by volume, preferably not less than 90% by volume, and more preferably not less than 95% by volume, relative to the entire amount of materials of which the porous film is made.

The porous film has many pores connected to one another. This allows a gas and a liquid to pass through the porous film from one side to the other side. Note that the pore is identical to the void.

The porous film has an AC resistance of preferably not more than 3.5 Ω·cm² and more preferably not more than 3.4 Ω·cm². If the AC resistance of the porous film is not more than 3.5 Ω·cm², the number of Li-ion paths is increased by excellent communicating property in the thickness direction of pores formed by the resin. Therefore, it is possible to inhibit an increase in air permeability after compression. A lower limit of the AC resistance of the porous film is not limited to a particular one, and may be, for example, not less than 0.1 Ω·cm². The AC resistance of the porous film may be not less than 0.1 Ω·cm² and not more than 3.5 Ω·cm².

The porous film has a thickness of 4 μm to 40 μm. The thickness of the porous film is preferably 5 μm to 20 μm. The porous film having a film thickness of not less than 4 μm makes it possible to sufficiently prevent an internal short circuit in a battery. The porous film having a thickness of not more than 40 μm makes it possible to prevent the nonaqueous electrolyte secondary battery from being large in size.

The polyolefin-based resin more preferably contains a high molecular weight component having a weight-average molecular weight of 5×10⁵ to 15×10⁶. In particular, the polyolefin-based resin more preferably contains a high molecular weight component having a weight-average molecular weight of not less than 1,000,000, because such a resin improves the strength of the porous film and the separator including the porous film.

The polyolefin-based resin is not limited to a particular one, and possible examples encompass thermoplastic resins such as homopolymers and copolymers which are each obtained by polymerizing a monomer(s) such as ethylene, propylene, 1-butene, 4-methyl-1-pentene, and/or 1-hexene. Examples of such homopolymers encompass polyethylene, polypropylene, and polybutene. Examples of such copolymers encompass an ethylene-propylene copolymer.

Among the above examples, polyethylene is more preferable because use of polyethylene makes it possible to prevent a flow of an excessively large electric current at a lower temperature in the separator. Preventing the flow of an excessively large electric current is also called “shutdown”. Examples of the polyethylene encompass low-density polyethylene, high-density polyethylene, linear polyethylene (ethylene-α-olefin copolymer), and ultra-high molecular weight polyethylene having a weight-average molecular weight of not less than 1,000,000. Among these examples, the ultra-high molecular weight polyethylene having a weight-average molecular weight of not less than 1,000,000 is more preferable.

The porous film typically has a weight per unit area of preferably 4 g/m² to 20 g/m², and more preferably 5 g/m² to 12 g/m², so as to allow a battery to have a higher weight energy density and a higher volume energy density.

The porous film has an air permeability of preferably 110 sec/100 mL to 200 sec/100 mL, and more preferably 110 sec/100 mL to 190 sec/100 mL, in terms of Gurley values, because such an air permeability enables a sufficient ion permeability.

The porous film has a porosity of preferably 20% by volume to 80% by volume, and more preferably 30% by volume to 75% by volume, so as to (i) retain a larger amount of electrolyte and (ii) obtain the function of reliably preventing (shutting down) a flow of an excessively large electric current at a lower temperature.

In order for the porous film and the separator including the porous film to have more excellent ion permeability after being compressed, the porosity of the porous film is more preferably not less than 35% by volume, and particularly preferably not less than 50% by volume.

The pore diameter of each pore of the porous film is preferably not more than 0.3 μm and more preferably not more than 0.14 μm, in view of (i) achieving sufficient ion permeability and (ii) preventing particles which constitute an electrode from entering the porous film.

### <Method of Producing Porous Film>

A method of producing a porous film in an embodiment of the present invention is not limited to a particular method, and specific examples encompass a method including the following steps (A) through (D):
(A) obtaining a polyolefin resin composition by melting and kneading, in a kneader, a polyolefin-based resin and optionally a pore forming agent;
(B) obtaining a primary sheet by stretching, while cooling, the obtained polyolefin resin composition in the MD to form a sheet;
(C) stretching the obtained primary sheet in the TD; and
(D) annealing the primary sheet, which has been stretched in the TD, by a heat treatment at a specific temperature for a specific time period to obtain a porous film.

In the step (A), the polyolefin-based resin is used in an amount of preferably 6% by weight to 45% by weight, and more preferably 9% by weight to 36% by weight, with respect to 100% by weight of the polyolefin resin composition to be obtained.

The pore forming agent is not limited to a particular one, and possible examples encompass plasticizers and inorganic bulking agents. The inorganic bulking agents are not limited to particular ones. Examples of the inorganic bulking agents encompass inorganic fillers (specifically, calcium carbonate and the like). The plasticizers are not limited to particular ones. Examples of the plasticizers encompass low molecular weight hydrocarbons such as liquid paraffin.

Examples of the additive encompass publicly known additives other than the pore forming agent, which additives can be optionally added to an extent that does not cause a deterioration in effects of the present invention. Examples of the publicly known additives encompass antioxidants, fillers, and dispersion auxiliary agents. Examples of the fillers encompass alumina.

In the step (B), the method of obtaining the primary sheet is not limited to a particular method. The primary sheet may be obtained by a sheet forming method such as inflation processing, calendering, T-die extrusion, or a Scaif method.

A sheet formation temperature in the sheet forming method, such as a T-die extrusion temperature in T-die extrusion, is preferably 200° C. to 280° C., and more preferably 220° C. to 260° C., for example.

A stretching temperature employed in the step (B) is preferably 120° C. to 160° C., and more preferably 130° C. to 155° C.

The method of cooling the polyolefin resin composition in the step (B) may be, for example, a method of bringing the polyolefin resin composition into contact with a cooling medium such as cool air or coolant water, or a method of bringing the polyolefin resin composition into contact with a cooling roller. The cooling method is preferably the method involving contact with a cooling roller.

If the polyolefin resin composition and the primary sheet contain a pore forming agent, the method of producing the polyolefin porous film includes a step of removing the pore forming agent by cleaning the primary sheet or the stretched primary sheet with use of cleaning liquid. The step of removing the pore forming agent is performed between the steps (B) and (C), or after the step (C).

The cleaning liquid is not limited to a particular one, as long as it is a solvent capable of removing the pore forming agent. Examples of the cleaning liquid encompass an aqueous hydrochloric acid solution, heptane, and dichloromethane.

In the step (C), the stretching temperature employed when performing stretching in the TD is preferably 80° C. to 120° C., and more preferably 80° C. to 115° C. The stretch ratio employed when performing stretching in the TD in the step (C) is preferably 2 times to 12 times, and more preferably 4 times to 10 times.

An upper limit of a stretching speed when carrying out stretching in the TD in the step (C) is preferably not more than 12 m/min, and more preferably not more than 10 m/min. A lower limit of the stretching speed is preferably not less than 0.5 m/min, and more preferably not less than 1 m/min. By carrying out stretching at a stretching speed within the above range, the primary sheet is easily uniformly stretched, and anisotropy is less likely to occur in pores. Therefore, it is possible to produce a porous film in which voids are more uniformly and more densely distributed.

The annealing in the step (D) is carried out at a temperature of preferably 110° C. to 140° C., and more preferably 115° C. to 135° C. The annealing is carried out for a period of preferably not less than 20 seconds to less than 20 minutes, and more preferably not less than 21 seconds to not more than 15 minutes. In the step (D), by carrying out the annealing for a long period, that is, for not less than 20 seconds, it is possible to produce a porous film in which voids are more uniformly and more densely distributed.

In an embodiment of the present invention, the stretching speed when stretching in the TD in the step (C) is controlled to a preferable range of not more than 12 m/min, and the period of annealing in the step (D) is controlled to a preferable range of not less than 20 seconds. This makes it possible to control the number of necessary stages to a suitable range of not more than 20 stages. The AC resistance of the separator can also be controlled to a preferable range of not more than 3.5 Ω·cm² by the above-described control method. In order to control the number of necessary stages and the AC resistance of the separator to preferable ranges, it is preferable that the relaxation operation in the MD is not carried out in the stretching step before annealing. By the relaxation operation, fibrils that form pores are bent, and the pores are more likely to become nonuniform. Therefore, the number of necessary stages of the separator is easily increased. In addition, the relaxation operation increases a probability that the resin parts overlap in the thickness direction, and decreases the communicating property of pores and thereby the number of Li-ion paths is reduced. Therefore, the AC resistance of the separator is likely to be high.

### <Insulating Porous Layer>

If the separator in accordance with an embodiment of the present invention is a laminated separator, the laminated separator preferably includes the porous film and an insulating porous layer formed on the porous film.

The insulating porous layer is typically a resin layer containing a resin. The insulating porous layer is preferably a heat-resistant layer or an adhesive layer. It is preferable that the resin of which the insulating porous layer is made be insoluble in the electrolyte of the battery and be electrochemically stable when the battery is in normal use. Hereinafter, the insulating porous layer may also be referred to simply as a “porous layer”.

The porous layer is formed on one surface or on both surfaces of the porous film, as necessary. If the porous layer is formed on one surface of the porous film, the porous layer is preferably formed on a surface of the porous film which surface faces a positive electrode of a nonaqueous electrolyte secondary battery to be produced, and more preferably on a surface of the porous film which surface comes into contact with the positive electrode.

It is preferable that the resin be insoluble in the electrolyte of the battery and, when the battery is in normal use, be electrochemically stable.

Specific examples of the resin encompass polyolefins, (meth)acrylate-based resins, fluorine-containing resins, polyamide-based resins, polyimide-based resins, polyester-based resins, rubbers, resins with a melting point or glass transition temperature of not lower than 180° C., water-soluble polymers, polycarbonate, polyacetal, and polyether ether ketone.

Of the above resins, polyolefins, (meth)acrylate-based resins, fluorine-containing resins, polyamide-based resins, polyester-based resins, and water-soluble polymers are preferable.

Preferable examples of the polyolefins include polyethylene, polypropylene, polybutene, and an ethylene-propylene copolymer.

Examples of the fluorine-containing resins include: polyvinylidene fluoride (PVDF), polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoro ethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer; and a fluorine-containing rubber having a glass transition temperature of not more than 23° C. among the fluorine-containing resins.

As the polyamide-based resins, aramid resins such as aromatic polyamides and wholly aromatic polyamides are preferable.

Specific examples of the aramid resins encompass poly(paraphenylene terephthalamide), poly(metaphenylene isophthalamide), poly(parabenzamide), poly(metabenzamide), poly(4,4′-benzanilide terephthalamide), poly(paraphenylene-4,4′-biphenylene dicarboxylic acid amide), poly(metaphenylene-4,4′-biphenylene dicarboxylic acid amide), poly(paraphenylene-2,6-naphthalene dicarboxylic acid amide), poly(metaphenylene-2,6-naphthalene dicarboxylic acid amide), poly(2-chloroparaphenylene terephthalamide), a paraphenylene terephthalamide/2,6-dichloroparaphenylene terephthalamide copolymer, and a metaphenylene terephthalamide/2,6-dichloroparaphenylene terephthalamide copolymer. Among these aramid resins, poly(paraphenylene terephthalamide) is more preferable.

The polyester-based resins are preferably aromatic polyesters such as polyarylates, and liquid crystal polyesters.

Examples of the rubbers include a styrene-butadiene copolymer and a hydride thereof, a methacrylate ester copolymer, an acrylonitrile-acrylic ester copolymer, a styrene-acrylic ester copolymer, ethylene propylene rubber, and polyvinyl acetate.

Examples of the resins each having a melting point or a glass transition temperature of not lower than 180° C. encompass polyphenylene ether, polysulfone, polyether sulfone, polyphenylene sulfide, polyetherimide, polyamide imide, and polyether amide.

Examples of the water-soluble polymers include polyvinyl alcohol, polyethylene glycol, cellulose ether, sodium alginate, polyacrylic acid, polyacrylamide, and polymethacrylic acid.

The porous layer may contain only one of the above resins or two or more of the above resins in combination.

The porous layer may contain fine particles. The term “fine particles” herein means organic fine particles or inorganic fine particles generally referred to as a filler. Therefore, if the porous layer contains fine particles, the above-described resin contained in the porous layer functions as a binder resin for (i) binding fine particles together and (ii) binding fine particles to the porous film. The fine particles are preferably electrically insulating fine particles.

Examples of the organic fine particles that can be contained in the porous layer encompass resin fine particles. Specific examples of the inorganic fine particles that can be contained in the porous layer encompass fillers made of inorganic matter such as calcium carbonate, talc, clay, kaolin, silica, hydrotalcite, diatomaceous earth, magnesium carbonate, barium carbonate, calcium sulfate, magnesium sulfate, barium sulfate, aluminum hydroxide, boehmite, magnesium hydroxide, calcium oxide, magnesium oxide, titanium oxide, titanium nitride, alumina (aluminum oxide), aluminum nitride, mica, zeolite, and glass. These inorganic fine particles are electrically insulating fine particles. It is possible to use only one type of the above fine particles, or two or more types of the above fine particles in combination.

Of the above fine particles, fine particles made of inorganic matter are suitable. More preferable are fine particles made of an inorganic oxide such as silica, calcium oxide, magnesium oxide, titanium oxide, alumina, mica, zeolite, aluminum hydroxide, or boehmite. Still more preferable are fine particles made of at least one selected from the group consisting of silica, magnesium oxide, titanium oxide, aluminum hydroxide, boehmite, and alumina. Particularly preferable are fine particles made of alumina.

The porous layer contains the fine particles in an amount of preferably 1% by volume to 99% by volume, and more preferably 5% by volume to 95% by volume, with respect to 100% by volume of the porous layer. Setting the amount of the fine particles to fall within the above range makes it less likely that the resin or the like will block a void which is formed when the fine particles come into contact with each other. This makes it possible to achieve sufficient ion permeability and an appropriate weight per unit area of the porous layer.

The porous layer can contain two or more kinds of fine particles in combination which two or more kinds differ from each other in particle size or specific surface area.

The porous layer has a thickness of preferably 0.5 μm to 15 μm per layer, and more preferably 2 μm to 10 μm per layer. Setting the thickness of the porous layer to be not less than 0.5 μm per layer makes it possible to sufficiently prevent an internal short circuit caused by, for example, breakage of the nonaqueous electrolyte secondary battery, and also to retain a sufficient amount of the electrolyte in the porous layer. Setting the thickness of the porous layer to be not more than 15 μm per layer makes it possible to reduce or prevent a decrease in a rate characteristic or cycle characteristic.

The weight per unit area of the porous layer is preferably 1 g/m² to 20 g/m² per layer and more preferably 4 g/m² to 10 g/m² per layer.

A volume per square meter of all component(s) contained in the porous layer is preferably 0.5 cm³ to 20 cm³ per layer, more preferably 1 cm³ to 10 cm³ per layer, and even more preferably 2 cm³ to 7 cm³ per layer.

For the purpose of achieving sufficient ion permeability, the porosity of the porous layer is preferably 20% by volume to 90% by volume, and more preferably 30% by volume to 80% by volume. In order for a laminated separator to have sufficient ion permeability, the pore diameter of each pore of the porous layer is preferably not more than 3 μm, and more preferably not more than 1 μm.

### <Laminated Separator>

The separator in accordance with an embodiment of the present invention may be a laminated separator.

The laminated separator has a thickness of preferably 5.5 μm to 45 μm and more preferably 6 μm to 25 μm.

The laminated separator has an air permeability of preferably 100 sec/100 mL to 350 sec/100 mL and more preferably 100 sec/100 mL to 300 sec/100 mL, in terms of Gurley values.

The separator in accordance with an embodiment of the present invention may include, as necessary, another porous layer other than the porous film and the porous layer, provided that the other porous layer does not prevent attainment of an object of an embodiment of the present invention. Examples of the other porous layer encompass publicly known porous layers such as a heat-resistant layer, an adhesive layer, and a protective layer.

The other porous layer may be provided on one surface or on both surfaces of the laminated separator. If the laminated separator includes insulating porous layers on both surfaces of the porous film, the other porous layer may be provided on both the insulating porous layers or on one of the insulating porous layers. If the laminated separator includes an insulating porous layer only on one surface of the porous film, the other porous layer may be provided on the insulating porous layer or on the other surface of the porous film where the insulating porous layer is not provided. The other porous layer may be said to be provided on the outermost layer of the laminated separator.

For example, the laminated separator further includes an adhesive layer in addition to the insulating porous layer. Herein, the adhesive layer refers to a porous layer having adhesiveness. The adhesive layer can be provided on a surface of the laminated separator that comes into contact with an electrode. Examples of a component that contributes to the adhesiveness in the adhesive layer encompass an acrylic resin, PVDF, and the like.

### <Method of Producing Porous Layer and Laminated Separator>

A method of producing the insulating porous layer in an embodiment of the present invention and the laminated separator in accordance with an embodiment of the present invention may be, for example, a method involving: applying a coating solution to one or both surfaces of the porous film, the coating solution containing the resin contained in the porous layer; and depositing the porous layer by drying the coating solution.

If the porous layer is to be deposited on both surfaces of the porous film, (a) the porous layer may be deposited on both surfaces of the porous film simultaneously, or (b) the coating solution may be applied to a first surface of the porous film and then dried so as to form a porous layer on the first surface, and then subsequently the coating solution may be applied to a second surface of the porous film and then dried so as to form a porous layer on the second surface.

Note that, before the coating solution is applied to one or both surfaces of the porous film, the one or both surfaces of the porous film to which the coating solution is to be applied can be subjected to a hydrophilization treatment as necessary.

The coating solution contains a resin to be contained in the porous layer. The coating solution may contain the below-described fine particles which may be contained in the porous layer. The coating solution can be prepared typically by (i) dissolving, in a solvent, the resin that can be contained in the porous layer and (ii) dispersing, in the solvent, the fine particles. The solvent in which the resin is to be dissolved also serves as a dispersion medium in which the fine particles are to be dispersed. Depending on the solvent, the resin may be an emulsion.

The solvent is not limited to any particular one, provided that (i) the solvent does not have an adverse effect on the porous film, (ii) the solvent allows the resin to be uniformly and stably dissolved in the solvent, and (iii) the solvent allows the fine particles to be uniformly and stably dispersed in the solvent. Specific examples of the solvent encompass water and organic solvents. It is possible to use only one of the above solvents or two or more of the above solvents in combination.

The coating solution may be formed by any method, provided that the coating solution can satisfy conditions, such as a resin solid content (resin concentration) and/or a fine particle amount, which are necessary for obtaining a desired porous layer. Specific examples of the method of forming the coating solution encompass a mechanical stirring method, an ultrasonic dispersion method, a high-pressure dispersion method, and a media dispersion method. Further, the coating solution may contain, as a component(s) other than the resin and the fine particles, an additive(s) such as a disperser, a plasticizer, a surfactant, and/or a pH adjustor, provided that the additive does not prevent attainment of an object of an embodiment of the present invention. The additive(s) may be contained in an amount that does not prevent attainment of an object of an embodiment of the present invention.

A method of applying the coating solution to the porous film, that is, a method of forming a porous layer on a surface of the porous film is not limited to any particular one. The porous layer can be formed by, for example, (i) a method including the steps of applying the coating solution directly to a surface of the porous film and then removing the solvent, (ii) a method including the steps of applying the coating solution to an appropriate support, removing the solvent to form a porous layer, then pressure-bonding the porous layer to the porous film, and subsequently peeling the support off, and (iii) a method including the steps of applying the coating solution to a surface of an appropriate support, then pressure-bonding the porous film to that surface, then peeling the support off, and subsequently removing the solvent.

The coating solution can be applied by a conventionally publicly known method. Specific examples of such a method include a gravure coater method, a dip coater method, a bar coater method, and a die coater method.

The solvent is typically removed by a drying method. The solvent contained in the coating solution may be replaced with another solvent before a drying operation.

### Embodiment 2: Nonaqueous Electrolyte Secondary Battery Member, Embodiment 3: Nonaqueous Electrolyte Secondary Battery

A nonaqueous electrolyte secondary battery member in accordance with Embodiment 2 of the present invention includes a positive electrode, the nonaqueous electrolyte secondary battery separator in accordance with Embodiment 1 of the present invention, and a negative electrode, the positive electrode, the nonaqueous electrolyte secondary battery separator, and the negative electrode being arranged in this order.

A nonaqueous electrolyte secondary battery in accordance with Embodiment 3 of the present invention includes the nonaqueous electrolyte secondary battery separator in accordance with Embodiment 1 of the present invention.

The nonaqueous electrolyte secondary battery in accordance with Embodiment 3 of the present invention can be, for example, a nonaqueous secondary battery that achieves an electromotive force through doping with and dedoping of lithium, and can include a nonaqueous electrolyte secondary battery member including (i) a positive electrode, (ii) the separator in accordance with Embodiment 1 the present invention, and (iii) a negative electrode, the positive electrode, the separator, and the negative electrode being arranged in this order. Note that components of the nonaqueous electrolyte secondary battery other than the separator are not limited to those described below.

The nonaqueous electrolyte secondary battery in accordance with Embodiment 3 of the present invention is typically configured so that a battery element is enclosed in an exterior member, the battery element including (i) a structure in which the negative electrode and the positive electrode face each other and sandwich the separator in accordance with Embodiment 1 of the present invention and (ii) an electrolyte with which the structure is impregnated. The nonaqueous electrolyte secondary battery is particularly preferably a lithium-ion secondary battery. Note that the doping refers to occlusion, support, adsorption, or insertion, and refers to a phenomenon in which lithium ions enter an active material of an electrode (e.g., a positive electrode).

The nonaqueous electrolyte secondary battery member in accordance with Embodiment 2 of the present invention includes the separator in accordance with Embodiment 1 of the present invention. Therefore, the nonaqueous electrolyte secondary battery member brings about an effect of suppressing a deterioration in battery performance caused by internal pressure occurring when charge and discharge are repeated in the nonaqueous electrolyte secondary battery. The nonaqueous electrolyte secondary battery in accordance with Embodiment 3 of the present invention includes the separator in accordance with Embodiment 1 of the present invention. Therefore, the nonaqueous electrolyte secondary battery brings about an effect of suppressing a deterioration in battery performance caused by internal pressure occurring when charge and discharge are repeated.

### <Positive Electrode>

The positive electrode included in (i) the nonaqueous electrolyte secondary battery member in accordance with an embodiment of the present invention and (ii) the nonaqueous electrolyte secondary battery in accordance with an embodiment of the present invention is not limited to a particular one, provided that the positive electrode is one that is typically used in a nonaqueous electrolyte secondary battery. Examples of the positive electrode encompass a positive electrode sheet having a structure in which an active material layer, containing a positive electrode active material and a binding agent, is formed on a current collector. The active material layer may further contain an electrically conductive agent.

Examples of the positive electrode active material encompass materials capable of being doped with and dedoped of lithium ions. Specific examples of the materials include lithium complex oxides each containing at least one transition metal such as V, Mn, Fe, Co, or Ni.

Examples of the electrically conductive agent encompass carbonaceous materials such as natural graphite, artificial graphite, cokes, carbon black, pyrolytic carbons, carbon fiber, and a fired product of an organic polymer compound. It is possible to use only one of the above electrically conductive agents, or two or more of the above electrically conductive agents in combination.

Examples of the binding agent encompass (i) fluorine-based resins such as polyvinylidene fluoride, (ii) acrylic resin, and (iii) styrene butadiene rubber. Note that the binding agent also serves as a thickener.

Examples of the positive electrode current collector encompass electric conductors such as Al, Ni, and stainless steel. Among these, Al is preferable because Al is easily processed into a thin film and is inexpensive.

Examples of a method for producing the positive electrode in sheet form encompass: a method in which a positive electrode active material, an electrically conductive agent, and a binding agent are pressure-molded on a positive electrode current collector; and a method in which (i) a positive electrode active agent, an electrically conductive agent, and a binding agent are formed into a paste with the use of a suitable organic solvent, (ii) then, a positive electrode current collector is coated with the paste, and (iii) subsequently, the paste is dried and then pressured so that the paste is firmly fixed to the positive electrode current collector.

### <Negative Electrode>

The negative electrode included in (i) the nonaqueous electrolyte secondary battery member in accordance with an embodiment of the present invention and (ii) the nonaqueous electrolyte secondary battery in accordance with an embodiment of the present invention is not limited to a particular one, provided that the negative electrode is one that is typically used in a nonaqueous electrolyte secondary battery. Examples of the negative electrode encompass a negative electrode sheet having a structure in which an active material layer, containing a negative electrode active material and a binding agent, is formed on a current collector. The active material layer may further contain an electrically conductive agent.

Examples of the negative electrode active material encompass (i) materials capable of being doped with and dedoped of lithium ions, (ii) a lithium metal, and (iii) a lithium alloy. Examples of the materials capable of being doped with and dedoped of lithium ions encompass carbonaceous materials. Examples of the carbonaceous materials encompass natural graphite, artificial graphite, cokes, carbon black, and pyrolytic carbons.

Examples of the negative electrode current collector include Cu, Ni, and stainless steel. Among these, Cu is more preferable because Cu is not easily alloyed with lithium especially in a lithium-ion secondary battery and is easily processed into a thin film.

Examples of a method for producing the negative electrode in sheet form encompass: a method in which a negative electrode active material is pressure-molded on a negative electrode current collector; and a method in which (i) a negative electrode active material is formed into a paste with the use of a suitable organic solvent, (ii) then, a negative electrode current collector is coated with the paste, and (iii) subsequently, the paste is dried and then pressured so that the paste is firmly fixed to the negative electrode current collector. The paste preferably contains the electrically conductive agent and the binding agent.

### <Nonaqueous Electrolyte>

A nonaqueous electrolyte in a nonaqueous electrolyte secondary battery in accordance with an embodiment of the present invention is not limited to any particular one, provided that the nonaqueous electrolyte is one that is generally used for a nonaqueous electrolyte secondary battery. The nonaqueous electrolyte can be one prepared by, for example, dissolving a lithium salt in an organic solvent. Examples of the lithium salt encompass LiClO₄, LiPF₆, LiAsF₆, LiSbF₆, LiBF₄, LiCF₃SO₃, LIN(CF₃SO₂)₂, LiC(CF₃SO₂)₃, Li₂B₁₀Cl₁₀, lower aliphatic carboxylic acid lithium salt, and LiAlCl₄. It is possible to use only one of the above lithium salts or two or more of the above lithium salts in combination.

Examples of the organic solvent to be contained in the nonaqueous electrolyte encompass carbonates, ethers, esters, nitriles, amides, carbamates, and sulfur-containing compounds, and fluorine-containing organic solvents each obtained by introducing a fluorine group into any of these organic solvents. It is possible to use only one of the above organic solvents or two or more of the above organic solvents in combination.

Aspects of the present invention can also be expressed as follows:

An embodiment of the present invention may include the features described in the following <1> through <7>.
<1> A nonaqueous electrolyte secondary battery separator including a polyolefin porous film, in which: when a binarized image is obtained by subjecting a two-dimensional image, which has a size of 960 pixels (thickness direction)×1280 pixels (MD) and which has been obtained from a cross section of the polyolefin porous film using a scanning electron microscope under conditions that a magnification is 5,000 times and one pixel is 19.8 μm×19.8 μm, to binarization into a void part region and a resin part region, and then the binarized image is subjected to an expansion process of expanding the void part region in stages, the number of necessary stages until the resin part region is filled with the void part region which has been expanded is not more than 20 stages; the expansion process is a process of repeating an operation of expanding each of target pixels constituting the void part region by 1 pixel per stage toward each of four pixels which are adjacent to respective four sides of that target pixel; and the expansion process and calculation of the number of necessary stages are carried out with the steps of
(1) extracting, from the two-dimensional image, an analysis region having a size of 100 pixels (thickness direction)×1280 pixels (MD),
(2) carrying out, with respect to the analysis region extracted in the step (1), a process of adaptive histogram equalization of a luminance value,
(3) carrying out a luminance inversion process with respect to the analysis region which has been subjected to the process of adaptive histogram equalization of a luminance value in the step (2),
(4) carrying out binarization by dividing all pixels constituting the analysis region which has been subjected to the luminance inversion process in the step (3) into pixels in which a luminance value is not more than a threshold of 180 and pixels in which a luminance value is more than the threshold of 180 within a luminance value range between 0 and 255,
(5) identifying, in the analysis region binarized in the step (4), a region constituted by the pixels in which the luminance value is more than the threshold of 180 as a void part region,
(6) carrying out, for each of void regions identified in the step (5) in the analysis region, an expansion operation in which each of pixels constituting a contour of that void part region is expanded by 1 pixel outwardly toward each of four adjacent pixels,
(7) carrying out a blob process with respect to a resin part region, which is a region other than the void part region subjected to the expansion operation in the step (6), counting the number of pixels constituting the resin part region, where the number of pixels thus counted is defined as the number of resin part regions, and then checking whether the number of resin part regions counted is 0 or not,
(8) ending the calculation of the number of necessary stages if the number of resin part regions counted in the step (7) is 0, repeating the processes described in the steps (6) and (7) until the number of resin part regions becomes 0 if the number of resin part regions is not 0, and ending the calculation of the number of necessary stages when the number of resin part regions has become 0, and
(9) calculating the number of times in which the processes described in the steps (6) and (7) have been repeated until the calculation of the number of necessary stages is ended in the step (8), and regarding the number of times thus calculated as the number of necessary stages.
<2> The nonaqueous electrolyte secondary battery separator according to <1>, further including: an insulating porous layer containing a resin.
<3> The nonaqueous electrolyte secondary battery separator according to <2>, in which: the resin is one or more types of resin selected from the group consisting of polyolefins, (meth)acrylate-based resins, fluorine-containing resins, polyamide-based resins, polyester-based resins, and water-soluble polymers.
<4> The nonaqueous electrolyte secondary battery separator according to <2> or <3>, in which the resin is an aramid resin.
<5> The nonaqueous electrolyte secondary battery separator according to any one of <2> through <4>, further including an adhesive layer in addition to the insulating porous layer.
<6> A nonaqueous electrolyte secondary battery member including: a positive electrode; the nonaqueous electrolyte secondary battery separator according to any one of <1> through <5>; and a negative electrode, the positive electrode, the nonaqueous electrolyte secondary battery separator, and the negative electrode being arranged in this order.
<7> A nonaqueous electrolyte secondary battery including: the nonaqueous electrolyte secondary battery separator according to any one of <1> through <5>.

Note that the scope of the nonaqueous electrolyte secondary battery separator, the nonaqueous electrolyte secondary battery member, and the nonaqueous electrolyte secondary battery in accordance with an embodiment of the present invention can encompass any combination of matters described in the foregoing features within the scope of the claims.

### EXAMPLES

The following description will discuss embodiments of the present invention in greater detail with reference to Examples and Comparative Examples. Note, however, that the present invention is not limited to Examples and Comparative Examples below.

### [Measurement Methods]

The methods described below were used to measure physical properties and the like of separators produced in Examples 1 through 4 and in Comparative Examples 1 and 2.

### (Thickness of Film)

The thickness of the separator was measured with the use of a high-precision digital measuring device (VL-50) manufactured by Mitutoyo Corporation.

### (Porosity)

### (a) Measurement of Thickness

The thickness of the separator was measured by the method described in the above-described section (Thickness of film).

### (b) Measurement of Weight Per Unit Area

From the separator, a square piece measuring 8 cm×8 cm was cut out as a sample, and a weight W (g) of the sample was measured. The following Formula (1) was then used to calculate a weight per unit area of the separator.

Weight per unit area (g/m²)=W/(0.08×0.08) . . . (1)

### (c) Measurement of Real Density

The separator was cut into a piece measuring 4 mm to 6 mm square, and the piece of the separator was vacuum-dried at not more than 30° C. for 17 hours. After that, a real density of the separator was measured by a helium gas replacement method by use of a dry automatic densimeter (AccuPye II 1340 manufactured by Micromeritics Instrument Corporation).

### (d) Calculation of Porosity

From the thicknesses [μm], the weight per unit area [g/m²], and the real density [g/m³] each calculated and measured in the processes described in (a) through (c) above, a porosity [%] of the separator was calculated based on Formula (2) below:

(Porosity)=[1−(weight per unit area)/{(thickness)×10⁻⁶×1[m²]×(real density)}]×100 (2)

### (Number-Average Number of Branches)

The number-average number of branches of polyethylene, which is a polyolefin-based resin used in Examples and Comparative Examples, was calculated by a method including the following steps 1 through 4.

Step 1: A standard sample was prepared that was constituted by linear polyolefin which had no branches and was of a type identical with polyolefin constituting the above-described polyolefin-based resin.

Step 2: For the standard sample prepared in the step 1, a conformation plot based on GPC-MALS was prepared using DAWN HELEOS II.

Step 3: For the polyolefin-based resin, a conformation plot based on GPC-MALS was prepared in a manner similar to that in the step 2.

Step 4: From the conformation plot prepared in the step 2 and the conformation plot prepared in the step 3, the number-average number of branches of the polyolefin-based resin was calculated based on the following formula.

$$g = \frac{{R}_{gb}^{2}}{{R}_{gL}^{2}} \\ g = {[ {( 1 + \frac{{B}_{n}}{7} )}^{\frac{1}{2}} + \frac{4 {B}_{n}}{9 π} ]}^{- \frac{1}{2}}$$

(where R_{gL} is a radius of gyration of a linear polyolefin-based resin, R_{gb} is a radius of gyration of a polyolefin-based resin having a branched structure, g is a value of (R_{gL}/R_{gb})² with an equivalent molecular weight, and Bₙ is the number of branches in a single molecular chain).

### (Ac Resistance)

By cutting a separator obtained in each of Examples and Comparative Examples, 23 discoid separator pieces each having a diameter of φ17 mm were obtained. By stacking five pieces out of the separator pieces, a coin cell separator A was prepared. By stacking eight pieces out of the separator pieces, a coin cell separator B was prepared. By stacking ten pieces out of the separator pieces, a coin cell separator C was prepared. Each of the coin cell separators A through C was sandwiched between two stainless steel (SUS) plate electrodes each having a thickness of 0.5 mm and a diameter of @15.5 mm, and an electrolyte was injected to obtain coin cells (CR2032 type) A through C. As the electrolyte, a solution was used in which LiPF₆ was dissolved in a mixed solvent in which ethylenecarbonate/ethyl methyl carbonate/diethyl carbonate were mixed at a volume ratio of 3/5/2 such that a concentration of the LiPF₆ was 0.1 mol/L. Next, measurement of an AC impedance was carried out with respect to each of the coin cells A through C using an AC impedance device (FRA11255B, manufactured by Solartron) under conditions of a frequency of 1 MHz to 0.1 Hz and an amplitude of 10 mV, and thus three types of Nyquist plots were obtained. From X intercept values of the respective three types of Nyquist plots, solution resistances of the respective laminated bodies (i.e., the coin cell separators A through C) obtained by stacking five, eight, and ten pieces out of the separator pieces were calculated. From an inclination obtained when the solution resistance value of each of the coin cell separators was plotted with respect to the number of separator pieces constituting that coin cell separator, a solution resistance per separator piece (Ω/piece) was calculated. By normalizing the solution resistance per separator piece by an electrode area (1.89 cm²), an AC resistance (Ω·cm²) of each of the separators obtained in Examples and Comparative Examples was calculated.

### (Number of Necessary Stages)

### <Obtainment of Cross-Sectional SEM Images>

Through a procedure including steps (i) through (iii) below, a cross section of the separator was observed using SEM.

(i) For the separator, an ion milling method was carried out with the use of a cross-sectional sample preparation device (IB-19520) manufactured by JEOL Ltd., and the separator was cut to form a cross section. The cross section was a cross section obtained by cutting the separator along a straight line that passes through a center of the separator and is parallel to the MD and in a direction perpendicular to the surface.

(ii) Osmium deposition was carried out on the cross section formed in the step (i), and thus a deposited film was formed on the cross section.

(iii) For the cross section in which the deposited film had been formed in the step (ii), a reflection electron image was observed at a magnification of 5000 times with use of a scanning electron microscope (S-4800, manufactured by Hitachi High-Technologies Corporation). Thus, an SEM image of the cross section (thickness direction: 960 pixels x MD: 1280 pixels) was obtained. The observation conditions at that time were as follows: an acceleration voltage of 0.8 kV and an operating distance of 3.0 mm. Note that, in the SEM image, one pixel corresponded to 19.8 μm×19.8 μm.

### <Calculation of Number of Necessary Stages>

Through a procedure including steps 1 through 9 below, image analysis of a cross-sectional SEM image was carried out to calculate the number of necessary stages.

1. By Python, a file (JPEG file) of image data of the cross-sectional SEM image was read.

2. From the image data read in the step 1, an analysis region having a size of 100 pixels (thickness direction)×1280 pixels (MD) was extracted. At that time, the analysis region was extracted so that the analysis region included the entire cross-sectional region of the separator (porous film).

3. With respect to the analysis region extracted in the step 2, a process of adaptive histogram equalization of a luminance value was carried out.

4. In order to accurately identify a void part when carrying out binarization, a luminance inversion process was carried out with respect to the analysis region which had been subjected to the process of adaptive histogram equalization of a luminance value in the step 3.

5. Under a condition of a threshold value of 180, the analysis region subjected to the luminance inversion process in the step 4 was binarized. That is, all pixels constituting the analysis region were divided, within a luminance value range between 0 and 255, into (i) pixels in which the luminance value was not more than the threshold value of 180 and (ii) pixels in which the luminance value was more than the threshold value of 180.

6. In the analysis region binarized in the step 5, a region constituted by the pixels in which the luminance value was more than the threshold value of 180 was identified as a void part region. For each of the identified void part regions, an operation was carried out in which each of pixels constituting the contour of that void part region was expanded by 1 pixel outwardly toward each of four adjacent pixels. In other words, an operation was carried out in which each of target pixels constituting that void part region was expanded by 1 pixel toward each of four pixels which were adjacent to respective four sides of that target pixel.

7. A region other than the void part region was regarded as a resin part region. Then, a blob process was carried out with respect to the resin part region, and the number of pixels constituting the resin part region was counted. The counted number of pixels was defined as the number of resin part regions. After that, it was checked whether the counted number of resin part regions was 0 or not.

8. If the number of resin part regions counted in the step 7 was 0, image analysis of the SEM image was ended. If the number of resin part regions was not 0, the processes of the steps 6 and 7 were repeated until the number of resin part regions became 0, and the image analysis was ended when the number of resin part regions became 0.

9. The number of times in which the processes described in the steps 6 and 7 were repeated until the image analysis was ended in the step 8 was calculated, and the number of times thus calculated was regarded as the number of necessary stages.

The adaptive histogram process of a luminance value described in the step 3 was specifically carried out in the following procedure.

(i) Image data was divided into partial regions each having a size of 8 pixels (longitudinal)×8 pixels (transverse) (corresponding to “adaptive”).

(ii) For each of the partial regions obtained in the step (i), a process of expanding a histogram of the image to an entire region (0 to 255 because 1 pixel was 8 bits) was carried out with use of OpenCV: cv::CLAHE Class Reference, which is an open source program (corresponds to the “histogram equalization process”).

Note that the histogram equalization process described in the step (ii) is automatically carried out by the open source program. Therefore, the number of necessary stages can be calculated uniquely by the above procedure.

(Difference Between Air Permeability/Thickness Before 20 MPa Compression and Air Permeability/Thickness after 20 MPa Compression)

Through a method including steps 1 through 5 below, a difference between air permeability/thickness before 20 MPa compression and air permeability/thickness after 20 MPa compression of the separator was measured.

Step 1: From the separator, a square piece measuring 6 cm×6 cm was cut out as a sample.

Step 2: The sample cut out in the step 1 was subjected to air permeability measurement in conformance with JIS P8117. The measured air permeability was considered to be air permeability (AP₁, unit: see/100 mL) of the separator which is not compressed. A thickness of the separator was measured with the use of a high-precision digital measuring device (VL-50) manufactured by Mitutoyo Corporation. The measured thickness was considered to be a thickness (t₁, unit: μm) of the separator which is not compressed.

Step 3: The sample cut out in the step 1 was sandwiched with aluminum plates, and was then pressed with a hydraulic compression molding machine (heat press machine (low load type) AH-1T, manufactured by AS ONE Corporation). The pressing conditions were 20 MPa, 35° C., and 5 minutes. Step 4: Measurement of air permeability and thickness was carried out in a manner similar to that in the step 2 also on the sample pressed in the step 3. The measured air permeability and the measured thickness were considered to be air permeability (AP₂, unit: see/100 mL) of the separator after compression, and a thickness (t₂, unit: μm) of the separator after compression, respectively.

Step 5: The difference between air permeability/thickness before 20 MPa compression and air permeability/thickness after 20 MPa compression of the separator was calculated based the following Formula (3) using AP₁, AP₂, t₁, and t₂ obtained in the steps 2 and 4.

(Difference between air permeability/thickness before 20 MPa compression and air permeability/thickness after 20 MPa compression)(unit:see/100 mL/μm){(AP₂)/(t₂)}−{(AP₁)/(t₁)} (3)

### Example 1

First, prepared was a mixture containing: 27.4 parts by weight of an ultra-high molecular weight polyethylene powder (intrinsic viscosity: 21 dL/g; viscosity average molecular weight: 3,000,000; number-average number of branches: 0.1; manufactured by Tosoh Corporation); 6.9 parts by weight of a polyethylene wax having a weight-average molecular weight of 4000 (EXCEREX 40800, manufactured by Mitsui Chemicals, Inc.), and 3.0 parts by weight of alumina (product name: AEROXIDE Alu65, manufactured by Nippon Aerosil Co., Ltd.). Then, 0.3 parts by weight of an antioxidant (IRGANOX 1010, manufactured by BASF), 0.1 parts by weight of an antioxidant (IRGAFOS 168, manufactured by BASF), 0.4 parts by weight of sodium stearate, and 0.6 parts by weight of a dispersion auxiliary agent (BYK-MAX P4102, manufactured by BYK) were added to 100 parts by weight of the mixture of (i) the ultra-high molecular weight polyethylene, (ii) the polyethylene wax, and (iii) the alumina so as to obtain a second mixture. Then, calcium carbonate having an average particle diameter of 0.07 μm (manufactured by Maruo Calcium Co., Ltd.) was added to the second mixture such that the volume of the calcium carbonate was 38% by volume with respect to the entire volume of a resultant mixture. The resultant mixture in the form of powder was mixed with a Henschel mixer, and was then melted and kneaded in a twin screw kneading extruder. In this way, a polyolefin resin composition was obtained. The polyolefin resin composition was extruded by a single screw extruder to obtain a resin sheet. A pair of heated rollers was used to stretch the resin sheet, so that a polyolefin resin composition in sheet form was obtained. The polyolefin resin composition in sheet form thus obtained was immersed in an aqueous hydrochloric acid solution (containing 4 mol/L of hydrochloric acid and 0.5% by weight of a nonionic surfactant) to remove the calcium carbonate, so that a primary sheet was obtained. Next, TD-wise ends of the primary sheet thus obtained were each held by a plurality of holding members that were arranged so as to be adjacent in the MD. Next, the primary sheet was stretched in the TD at a stretching speed of 10 m/min and to a stretch ratio of 7.05 times. The stretched primary sheet was then heat-treated at a temperature of 129° C. for 21 seconds for annealing to produce a porous film 1. The porous film 1 thus obtained was considered to be a separator 1.

### Example 2

First, prepared was a mixture containing: 70 parts by weight of an ultra-high molecular weight polyethylene powder (GUR4032; number-average number of branches: 0.5; manufactured by Ticona); and 30 parts by weight of a polyethylene wax having a weight-average molecular weight of 1000 (FNP-0115, manufactured by Nippon Seiro Co., Ltd.). Then, 0.4 parts by weight of an antioxidant (IRGANOX 1010, manufactured by BASF), 0.1 parts by weight of an antioxidant (IRGAFOS 168, manufactured by BASF), and 1.3 parts by weight of sodium stearate were added to 100 parts by weight of the mixture of (i) the ultra-high molecular weight polyethylene and (ii) the polyethylene wax so as to obtain a second mixture. Then, calcium carbonate having an average particle diameter of 0.1 μm (manufactured by Maruo Calcium Co., Ltd.) was added to the second mixture such that the volume of the calcium carbonate was 38% by volume with respect to the entire volume of a resultant mixture. The resultant mixture in the form of powder was mixed with a Henschel mixer, and was then melted and kneaded in a twin screw kneading extruder. In this way, a polyolefin resin composition was obtained. The polyolefin resin composition was extruded by a single screw extruder to obtain a resin sheet. A pair of heated rollers was used to stretch the resin sheet, so that a polyolefin resin composition in sheet form was obtained. The polyolefin resin composition in sheet form thus obtained was immersed in an aqueous hydrochloric acid solution (containing 4 mol/L of hydrochloric acid and 0.5% by weight of a nonionic surfactant) to remove the calcium carbonate, so that a primary sheet was obtained. Next, TD-wise ends of the primary sheet thus obtained were each held by a plurality of holding members that were arranged so as to be adjacent in the MD. Next, the primary sheet was stretched in the TD at a stretching speed of 10 m/min and to a stretch ratio of 7.05 times. The stretched primary sheet was then heat-treated at a temperature of 120° C. for 21 seconds for annealing to produce a porous film 2. The porous film 2 thus obtained was considered to be a separator 2.

### Example 3

A porous film 3 was produced by carrying out an operation similar to that in Example 2, except that the temperature of the heat treatment in the annealing was changed from 120° C. to 110° C., and the stretch ratio in the TD was changed from 7.05 times to 5.00 times. The porous film 3 thus obtained was considered to be a separator 3.

### Example 4

First, prepared was a mixture containing: 26.9 parts by weight of an ultra-high molecular weight polyethylene powder (intrinsic viscosity: 21 dL/g; viscosity average molecular weight: 1,500,000; number-average number of branches: 0.1; manufactured by Tosoh Corporation); and 10.7 parts by weight of a polyethylene wax having a weight-average molecular weight of 4000 (EXCEREX 40800, manufactured by Mitsui Chemicals, Inc.). Then, 0.3 parts by weight of an antioxidant (IRGANOX 1010, manufactured by BASF), 0.1 parts by weight of an antioxidant (IRGAFOS 168, manufactured by BASF), and 0.4 parts by weight of sodium stearate were added to 100 parts by weight of the mixture of (i) the ultra-high molecular weight polyethylene and (ii) the polyethylene wax so as to obtain a second mixture. Then, calcium carbonate having an average particle diameter of 0.07 μm (manufactured by Maruo Calcium Co., Ltd.) was added to the second mixture such that the volume of the calcium carbonate was 37% by volume with respect to the entire volume of a resultant mixture. The resultant mixture in the form of powder was mixed with a Henschel mixer, and was then melted and kneaded in a twin screw kneading extruder. In this way, a polyolefin resin composition was obtained. The polyolefin resin composition was extruded by a single screw extruder to obtain a resin sheet. A pair of heated rollers was used to stretch the resin sheet, so that a polyolefin resin composition in sheet form was obtained. The polyolefin resin composition in sheet form thus obtained was immersed in an aqueous hydrochloric acid solution (containing 4 mol/L of hydrochloric acid and 0.5% by weight of a nonionic surfactant) to remove the calcium carbonate, so that a primary sheet was obtained. Next, TD-wise ends of the primary sheet thus obtained were each held by a plurality of holding members that were arranged so as to be adjacent in the MD. Next, the primary sheet was stretched in the TD at a stretching speed of 10 m/min and to a stretch ratio of 7.05 times. The stretched primary sheet was then heat-treated at a temperature of 132° C. for 21 seconds for annealing to produce a porous film 4. The porous film 4 thus obtained was considered to be a separator 4.

### Comparative Example 1

A porous film C1 was produced by carrying out an operation similar to that in Example 2, except that the temperature of the heat treatment in the annealing was changed from 120° C. to 125° C., the stretching speed of stretching in the TD was changed to 15 m/min, and the heat treatment time in the annealing was changed from 21 seconds to 13 seconds. The porous film C1 thus obtained was considered to be a separator C1.

### Comparative Example 2

A porous film C2 was produced by carrying out an operation similar to that in Example 2, except that the temperature of the heat treatment in the annealing was changed from 120° C. to 128° C., the stretching speed of stretching in the TD was changed to 16 m/min, and the heat treatment time in the annealing was changed from 21 seconds to 14 seconds. The porous film C2 thus obtained was considered to be a separator C2.

### [Results]

Table 1 below indicates heat treatment times in the annealing in Examples 1 through 4 and Comparative Examples 1 and 2, and results of measuring, by the methods described above, the physical properties of the separators 1 through 4 and the separators C1 and C2 which were obtained in Examples 1 through 4 and Comparative Examples 1 and 2.

TABLE 1

| | | | Physical properties of separator | | | |
|---|---|---|---|---|---|---|
| | | | | | | Difference between air |
| | Production condition | | | | | permeability/thickness before 20 |
| | | Heating | | | Number of | MPa compression and air |
| | Stretching | treatment time | AC | Porosity | necessary | permeability/thickness after 20 MPa |
| | speed | in annealing | resistance | [% by | stages | compression |
| | [m/min] | [sec] | [Ω · cm²] | volume] | [stage] | [sec/100 mL/μm] |
| Example 1 | 10 | 21 | 1.6 | 73 | 17 | 11.12 |
| Example 2 | 10 | 21 | 2.4 | 62 | 18 | 19.10 |
| Example 3 | 10 | 21 | 1.7 | 66 | 14 | 21.45 |
| Example 4 | 10 | 21 | 3.4 | 42 | 18 | 13.15 |
| Comparative | 15 | 13 | 4.7 | 46 | 23 | 36.20 |
| Example 1 | | | | | | |
| Comparative | 16 | 14 | 3.8 | 32 | 33 | 33.04 |
| Example 2 | | | | | | |

As indicated in Table 1, the separators 1 through 4 according to Examples 1 through 4 each included the porous film for which the number of necessary stages was not more than 20 stages. Therefore, the separators 1 through 4 fall under the separator in accordance with an embodiment of the present invention. In contrast, the separators C1 and C2 according to Comparative Examples 1 and 2 each included the porous film for which the number of necessary stages was more than 20 stages. Therefore, the separators C1 and C2 do not fall under the separator according to an embodiment of the present invention. The difference between air permeability/thickness before 20 MPa compression and air permeability/thickness after 20 MPa compression is smaller in the separators 1 through 4 than in the separators C1 and C2, and a degree of increase in air permeability, i.e., a degree of decrease in ion permeability caused by the compression is smaller in the separators 1 through 4. Therefore, it has been found that the separator according to an embodiment of the present invention can satisfactorily maintain ion permeability even when the separator is compressed.

In Examples 1 through 4, the relaxation operation in the MD was not carried out in the stretching step before annealing. As indicated in Table 1, the separators 1 through 4 described in Examples 1 through 4 achieved the small number of necessary stages, and had the AC resistance values controlled to fall within the preferable range of not more than 3.5 Ω·cm². As such, it seems that, by omitting the relaxation operation in an embodiment of the present invention, the number of necessary stages is suitably reduced, and the value of AC resistance is also suitably reduced. In other words, if the relaxation operation is carried out, the number of necessary stages is large, and the number of necessary stages is more likely to exceed 20 stages.

### INDUSTRIAL APPLICABILITY

The separator in accordance with an embodiment of the present invention can satisfactorily maintain ion permeability even when the separator is compressed. Therefore, the separator in accordance with an embodiment of the present invention can be utilized as a separator for a high-capacity nonaqueous electrolyte secondary battery having a high internal pressure.

### REFERENCE SIGNS LIST

1: Void part region

The invention claimed is:

1. A nonaqueous electrolyte secondary battery separator including a polyolefin porous film, wherein:
when a binarized image is obtained by subjecting a two-dimensional image, which has a size of 960 pixels (thickness direction)×1280 pixels (MD) and which has been obtained from a cross section of the polyolefin porous film using a scanning electron microscope under conditions that a magnification is 5,000 times and one pixel is 19.8 μm×19.8 μm, to binarization into a void part region and a resin part region, and then the binarized image is subjected to an expansion process of expanding the void part region in stages, the number of necessary stages until the resin part region is filled with the void part region which has been expanded is not more than 20 stages;
the expansion process is a process of repeating an operation of expanding each of target pixels constituting the void part region by 1 pixel per stage toward each of four pixels which are adjacent to respective four sides of that target pixel; and
the expansion process and calculation of the number of necessary stages are carried out with the steps of
(1) extracting, from the two-dimensional image, an analysis region having a size of 100 pixels (thickness direction)×1280 pixels (MD),
(2) carrying out, with respect to the analysis region extracted in the step (1), a process of adaptive histogram equalization of a luminance value,
(3) carrying out a luminance inversion process with respect to the analysis region which has been subjected to the process of adaptive histogram equalization of a luminance value in the step (2),
(4) carrying out binarization by dividing all pixels constituting the analysis region which has been subjected to the luminance inversion process in the step (3) into pixels in which a luminance value is not more than a threshold of 180 and pixels in which a luminance value is more than the threshold of 180 within a luminance value range between 0 and 255,
(5) identifying, in the analysis region binarized in the step (4), a region constituted by the pixels in which the luminance value is more than the threshold of 180 as a void part region,
(6) carrying out, for each of void regions identified in the step (5) in the analysis region, an expansion operation in which each of pixels constituting a contour of that void part region is expanded by 1 pixel outwardly toward each of four adjacent pixels,
(7) carrying out a blob process with respect to a resin part region, which is a region other than the void part region subjected to the expansion operation in the step (6), counting the number of pixels constituting the resin part region, where the number of pixels thus counted is defined as the number of resin part regions, and then checking whether the number of resin part regions counted is 0 or not,
(8) ending the calculation of the number of necessary stages if the number of resin part regions counted in the step (7) is 0, repeating the processes described in the steps (6) and (7) until the number of resin part regions becomes 0 if the number of resin part regions is not 0, and ending the calculation of the number of necessary stages when the number of resin part regions has become 0, and
(9) calculating the number of times in which the processes described in the steps (6) and (7) have been repeated until the calculation of the number of necessary stages is ended in the step (8), and regarding the number of times thus calculated as the number of necessary stages.

2. The nonaqueous electrolyte secondary battery separator, according to claim 1, further comprising:
an insulating porous layer containing a resin.

3. The nonaqueous electrolyte secondary battery separator according to claim 2, wherein:
the resin is one or more types of resin selected from the group consisting of polyolefins, (meth)acrylate-based resins, fluorine-containing resins, polyamide-based resins, polyester-based resins, and water-soluble polymers.

4. The nonaqueous electrolyte secondary battery separator according to claim 2, wherein the resin is an aramid resin.

5. The nonaqueous electrolyte secondary battery separator according to claim 2, further comprising an adhesive layer in addition to the insulating porous layer.

6. A nonaqueous electrolyte secondary battery member comprising:
a positive electrode;
a nonaqueous electrolyte secondary battery separator according to claim 1; and
a negative electrode, the positive electrode, the nonaqueous electrolyte secondary battery separator, and the negative electrode being arranged in this order.

7. A nonaqueous electrolyte secondary battery comprising:
a nonaqueous electrolyte secondary battery separator according to claim 1.
